(19) United States
(12) Patent Application Publication
(10) Pub. No.: US 2013/0046611 A1
(43) Pub. Date: Feb. 21, 2013

(54) Method And Apparatus For Recycling Electronic Devices

(71) Applicant: ecoATM, Inc., San Diego, CA (US)

(72) Inventors: Mark Vincent Bowles, La Jolla, CA (US); Jeff Ploetner, San Diego, CA (US); John Andrew Beane, San Diego, CA (US)

(73) Assignee: ecoATM, Inc., San Diego, CA (US)

(21) Appl. No.: 13/658,825

(22) Filed: Oct. 24, 2012

Related U.S. Application Data
(63) Continuation-in-part of application No. 13/492,835, filed on Jun. 9, 2012.
Application No. 13/492,835 is a continuation of application No. 12/785,465, filed on May 23, 2010, now Pat. No. 8,200,533.
Application No. 12/785,465 is a continuation-in-part of application No. 12/727,624, filed on Mar. 19, 2010, now Pat. No. 7,881,965.
Application No. 12/727,624 is a continuation-in-part of application No. 12/573,089, filed on Oct. 2, 2009, now Pat. No. 8,195,511.
(60) Provisional application No. 61/551,410, filed on Oct. 25, 2011.
(60) Provisional application No. 61/606,997, filed on Mar. 6, 2012.
(60) Provisional application No. 61/102,304, filed on Oct. 2, 2008.
(60) Provisional application No. 61/183,510, filed on Jun. 2, 2009.

(51) Int. Cl. G06Q 10/00

(52) U.S. Cl. 705/14.37

(57) ABSTRACT

A recycling kiosk for recycling and financial remuneration for submission of an electronic device is disclosed herein. The recycling kiosk includes an inspection area with preferably two mirrored, domed hemispheres positioned about a transparent table and cameras for imaging an electronic device placed on the table. Inspection of an About page or a barcode within a battery compartment of the electronic device is performed to determine a value for the electronic device.

### CROSS REFERENCE TO RELATED APPLICATION

The present application claims priority to U.S. Provisional Patent Application 61/551,410 filed on Oct. 25, 2011, claims priority to U.S. Provisional Patent Application 61/606,997 filed on Mar. 6, 2012, and is also a continuation-in-part application of U.S. patent application Ser. No. 13/492,835, filed on Jun. 9, 2012, which is a continuation application of U.S. patent application Ser. No. 12/785,465, filed on May 23, 2010, now U.S. Pat. No. 8,200,533, issued on Jun. 12, 2012, which is a continuation-in-part application of U.S. patent application Ser. No. 12/727,624, filed on Mar. 19, 2010, now U.S. Pat. No. 7,881,965, which issued on Feb. 1, 2011, which is a continuation-in-part application of U.S. patent application Ser. No. 12/573,089, filed on Oct. 2, 2009, now U.S. Pat. No. 8,195,511, issued on Jun. 5, 2012, which claims priority to U.S. Provisional Patent Application 61/102,304 filed on Oct. 2, 2008, now abandoned, and 61/183,510 filed on Jun. 2, 2009, now abandoned, all of which are herein incorporated by reference in their entireties.

### STATEMENT REGARDING FEDERALLY SPONSORED RESEARCH OR DEVELOPMENT

Not Applicable

### BACKGROUND OF THE INVENTION

1. Field of the Invention

The present invention generally relates to recycling of mobile phones.

More specifically, the present invention relates to a kiosk for visually analyzing mobile phones and providing remuneration to an owner for recycling of the mobile phone.

2. Description of the Related Art

There has been a large increase in the number of electronic devices used by the typical consumer. These devices include cell phones, PDA's, mp3 players, GPS devices, cameras, beepers, remote controls, cordless phones, calculators, etc. The rapid pace at which new technology and models of electronic devices are introduced creates a situation where many consumers upgrade or replace one or more recyclable device on a frequent basis. Often, the consumer does not dispose of the prior electronic device, but rather just stops using it and begins using the new device. This may happen over several generations of such devices.

In addition to the electronic devices mentioned above, there are many other types of devices that have relatively high frequency replacement rates, including portable mobile electronic devices, such as cell phones, MP3 players, etc, and non-portable electronic devices, such as computers, printers, and the like. In addition to electronic devices, there are content based digital media such as games on CD, DVD, or cartridge, or entertainment mass storage items such as CDs, DVDs, BluRay, etc. There is a need for handling of such items in an ecologically friendly manner, both via recycling or by proper disposal procedures. It has not been convenient for owners of electronic devices to either recycle such devices or to properly dispose of such devices. There is currently little incentive for a device owner to “do the right thing” with a used device. When the owner just stops using a device and simply puts it in storage: the opportunity for recycling or re-use by another party is lost. If the owner just throws the device away in normal trash containers, the proper recycling or safe disposing of the device is thwarted.

One particular problem associated with this phenomenon can be illustrated by an example of mobile phones. There are more than 3.6 billion mobile phone users in the world with an annual growth of 10% per annum. The replacement rate of mobile handsets is roughly every 18 months as new models have more features and new standards evolve. Wireless carriers also offer new phones below cost, or free, as incentives to get customers to sign lucrative two-year service contracts ensuring a constant build-up of old mobile phones. Old mobile phones and other mobile devices (pagers, PDAs) present a growing threat to the environment. As of 2007, there are more than 750 million mobile phones waiting to be recycled in the US, either in drawers or already in the waste stream. Another 150+ million or so are added every year. Once in the waste stream, these devices may leak Lead, Mercury, Cadmium, Arsenic and other toxic substances into the water supply. Municipalities often incinerate their waste, instantly putting these toxic elements into the air, and they return to earth in rain water. A problem that needs to be solved is to make it easy and accessible for the public to recycle or resell their mobile phones and other recyclable devices. Two reasons why mobile phones are not being recycled or resold are difficult access to recycling or reselling facilities, and secondly security concerns about the information stored on the mobile phone. In addition to mobile phones, the same problems apply to many other electronic devices.

Technology has not yet provided a resolution to this problem. One invention is Bishop, U.S. Pat. No. 4,951,308 for Automated Vending Of Cellular Hand-Held Telephones And Cellular Telephone Services, which discloses a vending machine that dispenses cellular telephones purchased by consumers through the vending machine. Bishop essentially adds to the problem by making it easier to acquire mobile phones.

Taylor et al., U.S. Patent Publication Number 2009/0190142, for a Method And System For Connecting A Data Storage Device To A Kiosk, discloses a kiosk with a docking port and an optical recognition device for identifying a data port on a data storage device. Taylor is directed at printing digital images at a photo kiosk.

The prior art has failed to recognize the problems associated with recycling mobile phones in a manner that is enticing to a consumer yet financially rewarding to the recycler. Further, the prior art has failed to determine an automated means for visually inspecting a LCD screen of a mobile phone to determine if the LCD screen is damaged.

### BRIEF SUMMARY OF THE INVENTION

The present invention enables one to securely recycle, donate, trade-in, and/or sell mobile phones in a publicly accessible location. In an embodiment where mobile phones are recycled, the invention is used by a mobile phone owner to submit his/her mobile phone for recycling via a recycling kiosk and receive compensation in some manner. The compensation might be dispersed via cash, voucher, credit or debit card, or other magnetic or electronic transaction methods.

In one embodiment, a method for conducting the collection of previously used electronic devices for the purpose of recycling and refurbishing uses a kiosk in a publicly accessible location. The kiosk displays one or more transaction options. The method further includes interaction between the user and the kiosk display options which may include powering the electronic device, testing and optical scanning, erasing of the stored data in the electronic device, determination and acceptance by consumer of compensation for the electronic device's value. The method may further include selection by consumers through interaction with the kiosk a variety of compensation methods including dispensing of cash, or redeemable voucher via coupon, or credit card debiting or crediting, electronic donation to user specified charity or charities, or other electronic payment methods.

One aspect of the present invention is a method for analysis of an electronic device and financial remuneration to a user for submission of the electronic device. The method comprises positioning an electronic device in an inspection area of a kiosk, wherein the inspection area has an imaging component such as a camera. The inspection area preferably has near-infrared lighting. The method further comprises imaging a barcode sticker of the electronic device and analyzing information derived from the barcode sticker of the electronic device. Lastly, the method comprises determining a value for the electronic device. The method may further comprise automatically binning the electronic device after determining the value of the electronic device. Preferably, the method comprises the user to remove a back panel and a battery of the electronic device prior to positioning the electronic device in the inspection area.

The kiosk of the method comprises a housing, the housing comprising a user interface on an exterior surface of the housing for the user to input information, an upper dome and a lower dome, wherein the upper dome and the lower dome comprise a plurality of mirrors. The kiosk further comprises an upper chamber imaging component (such as a camera), a lower chamber imaging component (such as a camera or scanner) and a transparent surface. The kiosk further comprises a processor within the housing and in communication with the at least one imaging component, the processor configured to identify the brand and model number of the electronic device based on at least one of the information from the user and the images from the at least one imaging component, the processor configured to determine a financial remuneration value for the electronic device.

Another aspect of the present invention is a method for analysis of an electronic device and financial remuneration to a user for submission of the electronic device. The method comprises positioning an electronic device in an inspection area of a kiosk, the inspection area having a camera. The method further comprises imaging a screen shot of a about page of the electronic device, and inspecting the screen shot of the about page of the electronic device obtained by at least one camera disposed in the inspection area to determine if the electronic device has any defects. The method further comprises determining a value for electronic device. Lastly the method comprises determining a value for the electronic device.

The kiosk of the method comprises a housing, a user interface on an exterior surface of the housing for the user to input information, an upper dome and a lower dome, wherein the upper dome and the lower dome comprise a plurality of mirrors. The kiosk further comprises an upper chamber camera, a lower chamber camera and a transparent surface. The kiosk also comprises a processor within the housing and in communication with the at least one camera, the processor configured to identify the brand and model number of the electronic device based on at least one of the information from the user and the images from the at least one camera, the processor configured to determine a financial remuneration value for the electronic device. Preferably, the method further comprises comparing information derived from the barcode sticker to information derived from the about page.

An additional aspect of the present invention is a method for analysis of an electronic device and financial remuneration to a user for submission of the electronic device. The method comprises positioning an electronic device in an inspection area of a kiosk wherein the inspection area has a camera. The method further includes using a robotic finger to activate the electronic device and imaging the electronic device. The image of the electronic device obtained by at least one camera disposed in the inspection area is inspected to determine if the electronic device has any defects. Lastly, the method includes determining a value for electronic device.

Yet another aspect of the present invention is a dome shaped apparatus, the dome shaped apparatus comprising an upper dome, a lower dome and the upper and lower dome comprising a plurality of walls, wherein the plurality of walls are composed of mirrors. The dome shaped apparatus further comprises a transparent surface and at least one camera, the camera capable of obtaining a multiple views of an electronic device placed within the dome shaped apparatus. The upper dome preferably comprises an upper chamber camera. The lower dome preferably comprises a lower chamber camera. Preferably, a combination of the each of the upper dome and lower dome cameras and the plurality of mirrors allow for an image of the device placed on the transparent surface. Preferably, the combination of the each of the upper dome and lower dome cameras and the plurality of mirrors allow for a 360 degrees of the electronic device placed on the transparent surface.

Yet another aspect of the present invention is a method for reading a serial number of a mobile phone for the purpose of tracking the mobile phone. The method includes requesting a user at a kiosk to dial *#06# into the mobile phone. The method also includes displaying the IMEI number or unique serial number on a display screen of the mobile phone. The method also includes reading the IMEI number or unique serial number on a display screen of the mobile phone with an imaging system of the kiosk that utilizes OCR to identify and track the serial number/mobile phone.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is a perspective view of a recycling kiosk.

FIG. 1A is a front view of the recycling kiosk of FIG. 1.

FIG. 1B is an isolated view of a front of the recycling kiosk of FIG. 1.

FIG. 1C is an isolated view of a front of the recycling kiosk of FIG. 1.

FIG. 2 is an isolated view of an electrical connector wheel.

FIG. 2A is an isolated view of an electrical connector is a staging area.

FIG. 2B is an isolated view of an electrical connector in a detached position.

FIG. 2C is an isolated view of an electrical connector being detached.

FIG. 2D is an isolated view of an electrical connector being retracted.

FIG. 3 is a perspective view of internal components of a kiosk.

FIG. 3A is a perspective view of internal components of a kiosk.

FIG. 3B is a perspective view of internal components of a kiosk.

FIG. 3C is a perspective view of internal components of a kiosk.

FIG. 4 is an isolated view of a phone an inspection plate of a kiosk.

FIG. 4A is an isolated view of a phone being transferred in the kiosk.

FIG. 4B is an isolated view of a phone being transferred in the kiosk.

FIG. 4C is an isolated view of a phone being binned in the kiosk.

FIG. 5 is a block diagram of components of a recycling kiosk.

FIG. 6 is a block diagram of components of a recycling kiosk.

FIG. 7 is an isolated view of an inspection area of a kiosk.

FIG. 8 is an isolated view of a camera in a dome of a kiosk.

FIG. 9 is an isolated view of a phone in an inspection area of a kiosk.

FIG. 10 is a front view of a phone.

FIG. 11 is a front view of a phone connected to an electrical connector.

FIG. 12 is a flow chart for recycling an electronic device.

FIG. 13 is a flow chart for a pre-acquisition auction method.

FIG. 14 is a flow chart of a method for analyzing an electronic device.

FIG. 15 is a flow chart of a method for analyzing an electronic device.

FIG. 16 is a flow chart of a method for analyzing an electronic device.

FIG. 17 is an isolated view of a LCD screen of a mobile phone illustrating a white screen.

FIG. 18 is an isolated view of a LCD screen of a mobile phone illustrating a telephone number.

FIG. 19 is an isolated view of a LCD screen of a mobile phone illustrating a national park.

FIG. 20 is an isolated view of a mobile phone in an inspection area of a recycling kiosk illustrating a field of view of a camera of the mobile phone.

### DETAILED DESCRIPTION OF THE INVENTION

The invention allows for automatic visual analysis of a mobile phone to determine if a LCD screen of the mobile is damaged in order to ascertain a value for recycling the mobile phone. The method for analyzing a mobile phone is preferably performed at a recycling kiosk. Mobile phones are preferably partitioned into three basic shapes: 1) a flip phone or clam shell type such as the MOTOROLA RAZR; 2) a slider phone which exposes a keyboard or screen such as the MOTORLA DROID; and 3) a bar shape phone such as the Apple iPHONE or the Research in Motion BLACKBERRY. The invention is also utilized with a network of kiosks in public spaces that perform a combination of recycling processing steps that receive, identify, visually inspect, electrically test, electrically erase, grade quality, containerize (bag), label, and inventory recyclable electronic devices. Each kiosk determines some form of compensation to an owner of the device. This compensation is preferably in the form of a direct payment, a credit on an account, a donation to a charity, a discount coupon for future purchases, or some similar form of compensation. The device owner has the choice to accept the offered compensation or reverse the transaction and retrieve the device.

In the following description, an example is given with respect to mobile phones. However, those skilled in the pertinent art will recognize that the system can be implemented with any number of other devices that have a LCD screen, without departing from the spirit and scope of the system.

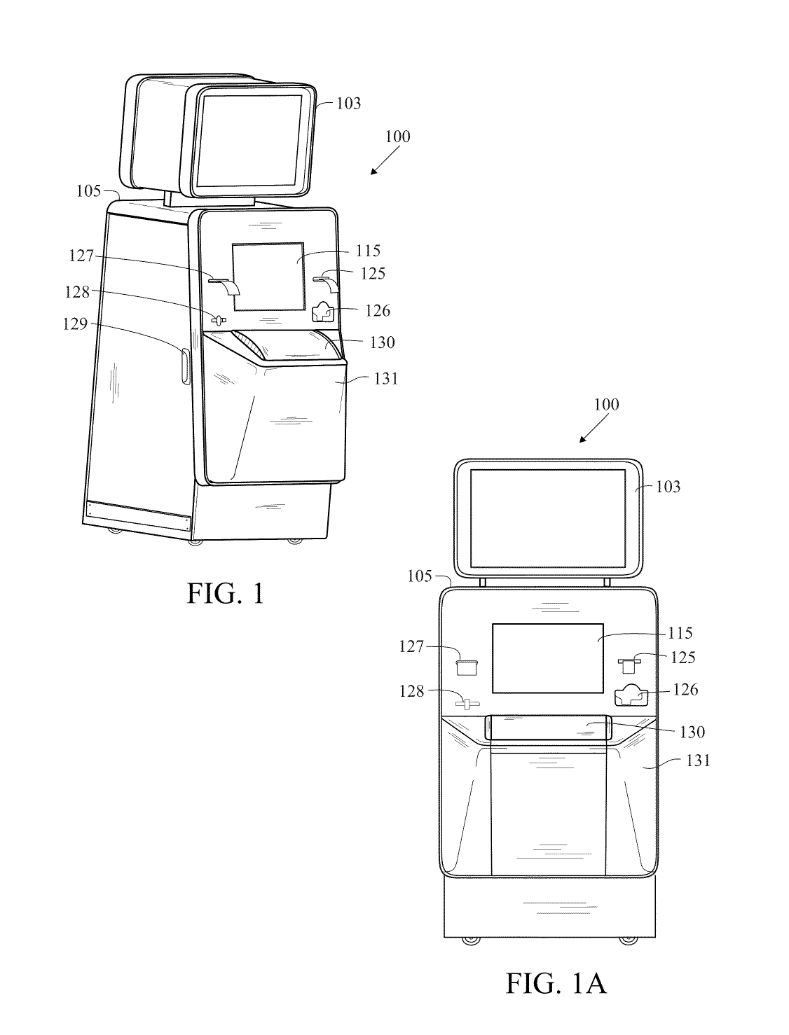

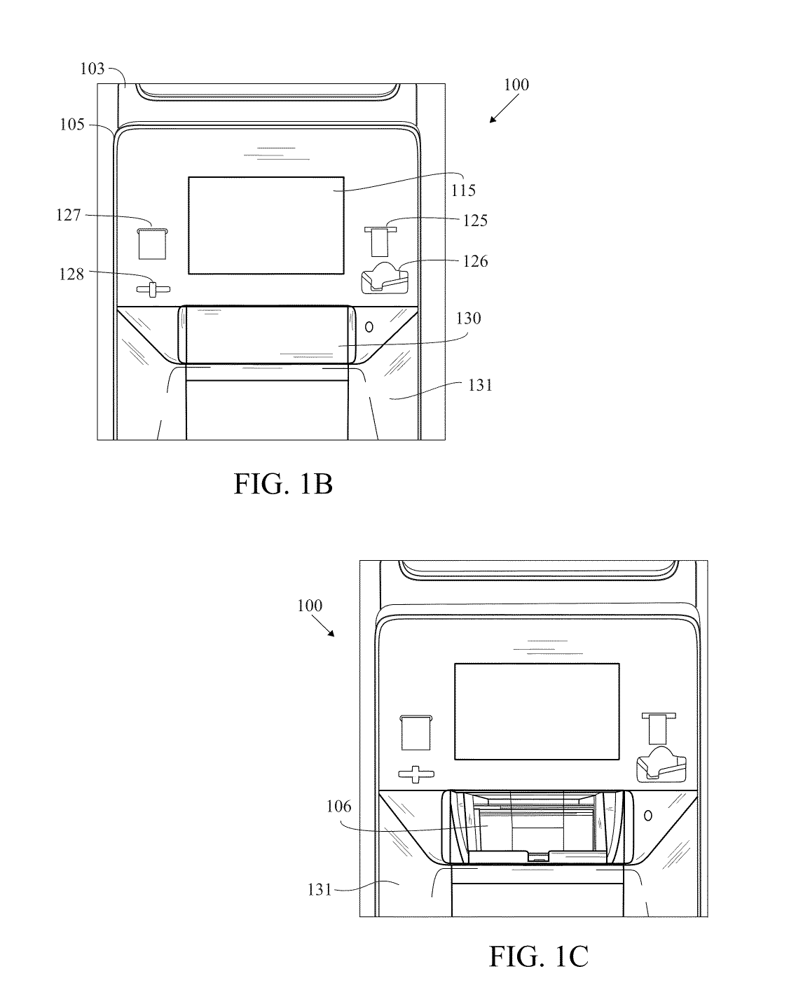

As shown in FIGS. 1, 1A, 1B and 1C, a kiosk for recycling electronic devices and providing financial remuneration is generally designated 100. The electronic device may be a Smart Phone, mobile phone, tablet computer, IPOD® device, MP3 Player, GPS device, e-reader, etc. The kiosk 100 has a housing 105 in a pseudo-rectangular cube shape. A header 103 allows for marketing and videos. An access door 130 in a front body area 131 provides access to an inspection area 106 for electronic devices. The front of the housing 105 has a display screen 115 for providing information to a user, and acts as a user interface in a touch screen embodiment. The exterior of the housing 105 also preferably has a label printer 125, a voucher dispenser 126, a receipt printer 127, and a cash or card dispenser 128. The exterior housing may also have a thumbprint reader.

The kiosk 100 allows for automatic visual analysis of an electronic device to identify the electronic device and to determine electronic device is damaged in order to ascertain a value for recycling the electronic device. Further, the kiosk 100 also allows for electrical analysis of the electronic device. An additional explanation of a recycling kiosk is set forth in U.S. patent application Ser. No. 13/438,924, filed on Apr. 4, 2012, for a Kiosk For Recycling Electronic Devices, which is hereby incorporated by reference in its entirety.

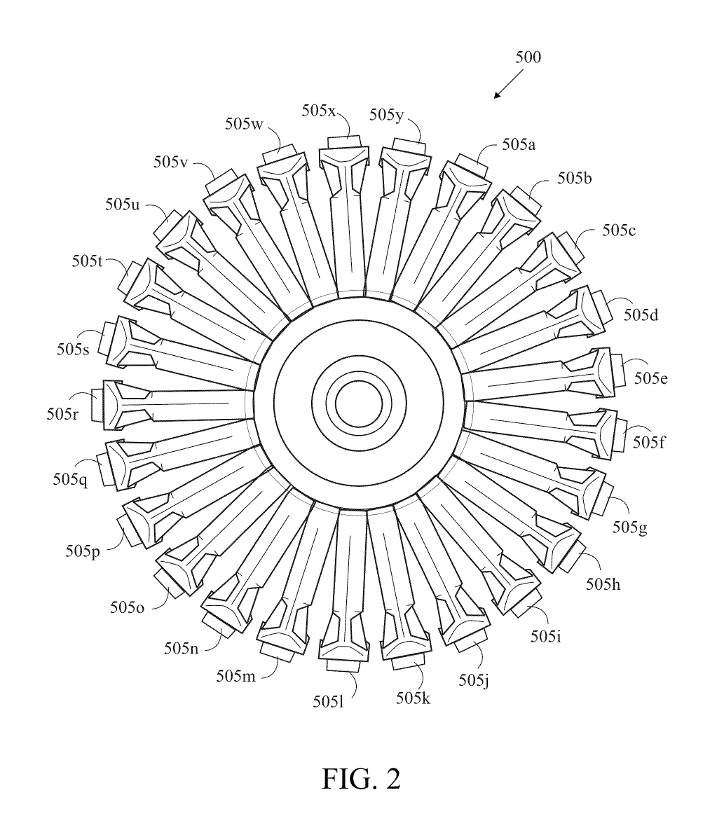

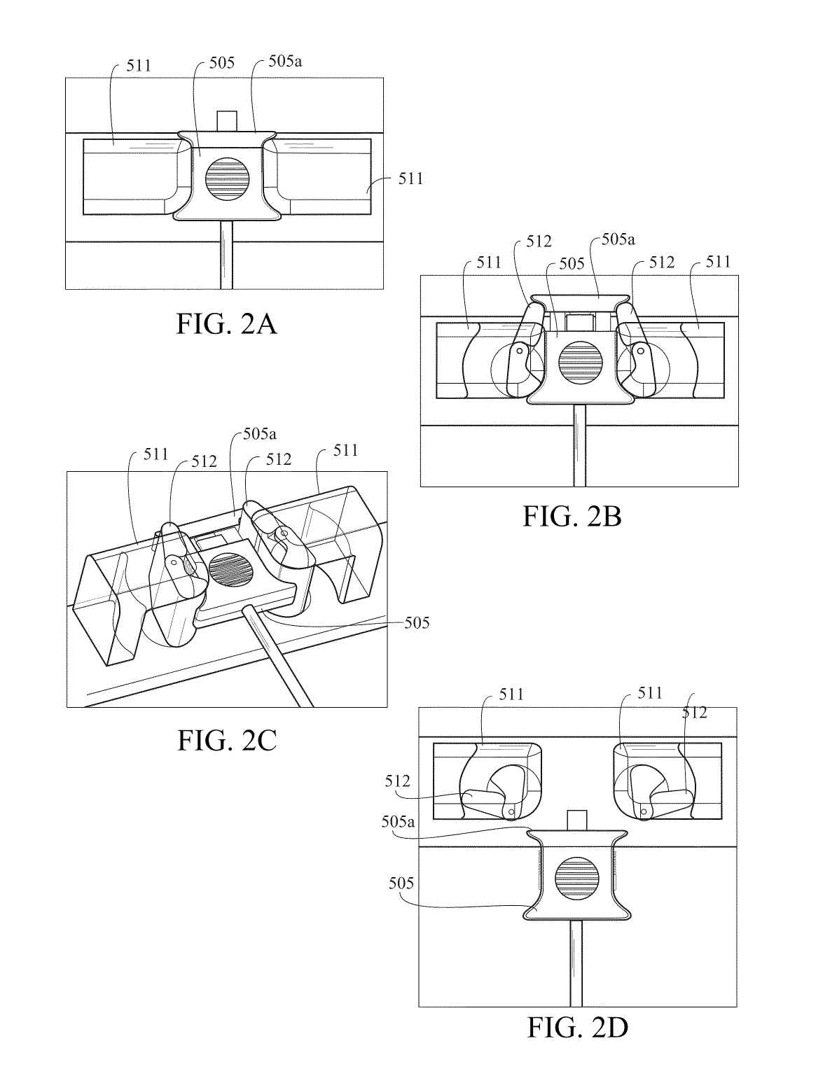

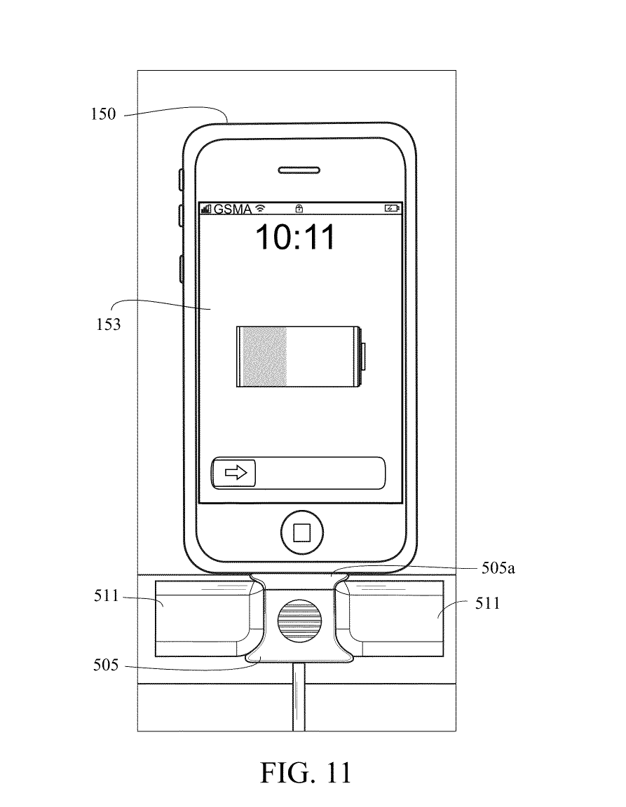

As shown in FIGS. 2, 2A, 2B, 2C and 2D, the kiosk 100 comprises a carousel 500 containing a plurality of electrical connectors 505a-505y. Each of the electrical connectors 505 has a unique connection plug for removable connection to an electronic device. Each of the electrical connectors 505a-505y has a cartridge removeably secured in the carousel 500. Thus, new electrical connectors 505 can be substituted for older electrical connectors 505. Further, the kiosk 100 is designed to allow for automatic removal of the electrical connector 505 using detachment mechanism 511. In FIG. 2A, the electrical connector 505 is in a staging area, where it would be connected to a port of an electrical device (as shown FIG. 11). Next, as shown in FIGS. 2B and 2C, hinged arms 512 of the detachment mechanism 511 engage a moveable member of the electrical connector 505 to force the outward movement of the moveable member and the disconnection of the electrical connector 505 from a port of an electronic device (as shown in FIG. 11). As shown in FIG. 2D, the electrical connector 505 is retracted by a cable from the detachment mechanism 511.

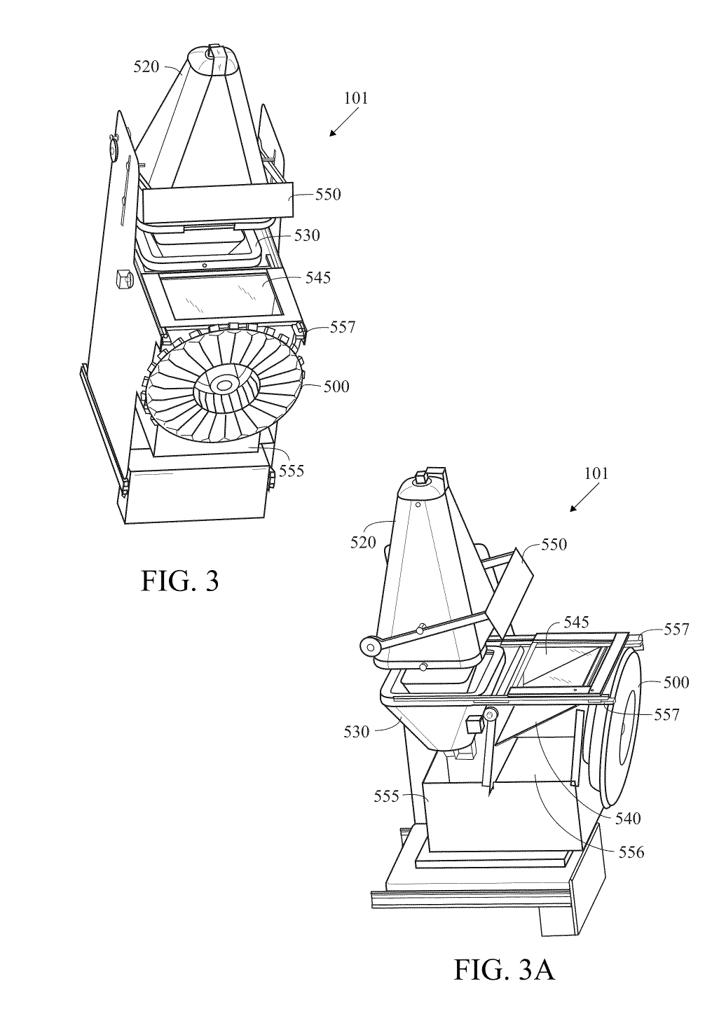

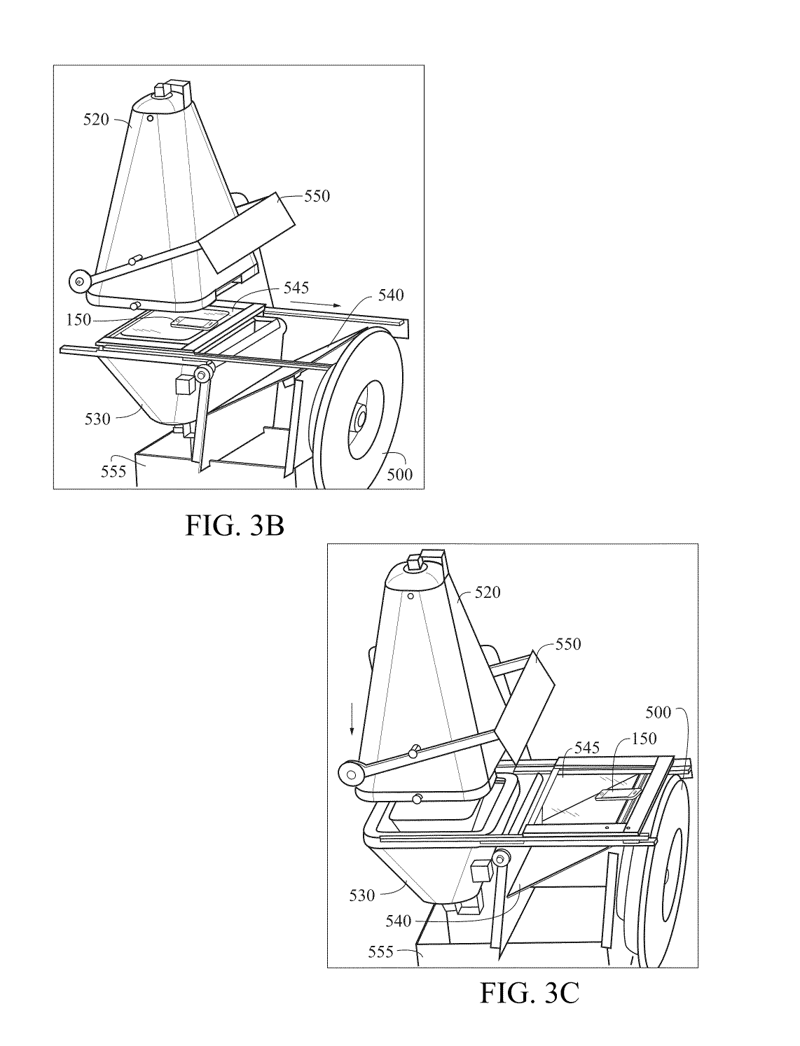

As shown in FIGS. 3, 3A, 3B and 3C, the internal mechanism 101 of the kiosk 100 includes an upper chamber 520, a lower chamber 530, a binning plate 540, a transparent plate 545, a door 550, a bin 555 and the carousel 500. Preferably, the carousel 500 is able to hold approximately 25 electrical connectors 505, wherein the electrical connectors 505 are interchangeable to easily adapt to the variations in USB and other like connections. As shown in FIG. 3B, a mobile phone 150 is placed on the transparent plate 545 and transferred to an inspection area 106 within upper chamber 520 and lower chamber 530. Both the upper chamber and the lower chamber preferably have a bell-like shape. As shown in FIG. 3C, the mobile phone is moved between the upper chamber 520 and the lower chamber 530 for visual analysis. The transparent plate, preferably composed of glass of a transparent plastic material, allows for imaging components within the upper chamber 520 and lower chamber 530 to obtain multiple view images of the mobile phone 150. Preferably, a 3-D profile of the mobile phone is generated in order to provide visual analysis for identification and condition of the mobile phone. Once the visual analysis is complete, the transparent plate 545 moves out from between the upper chamber 520 and lower chamber 530.

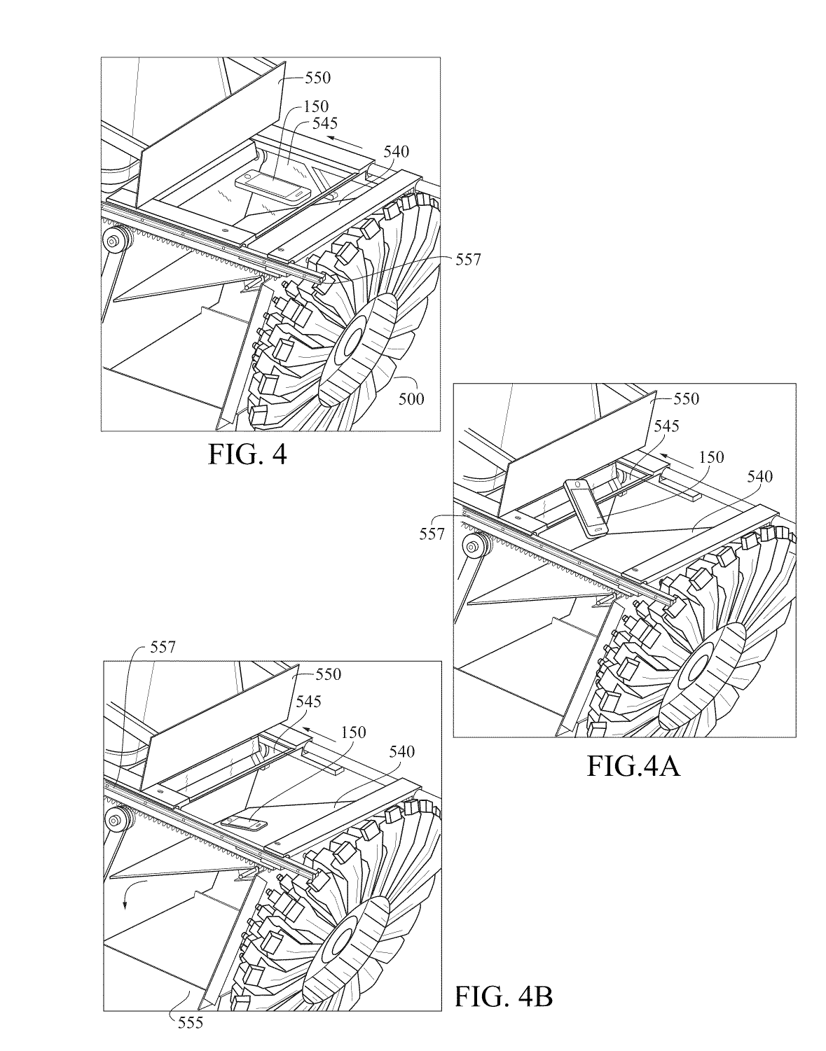

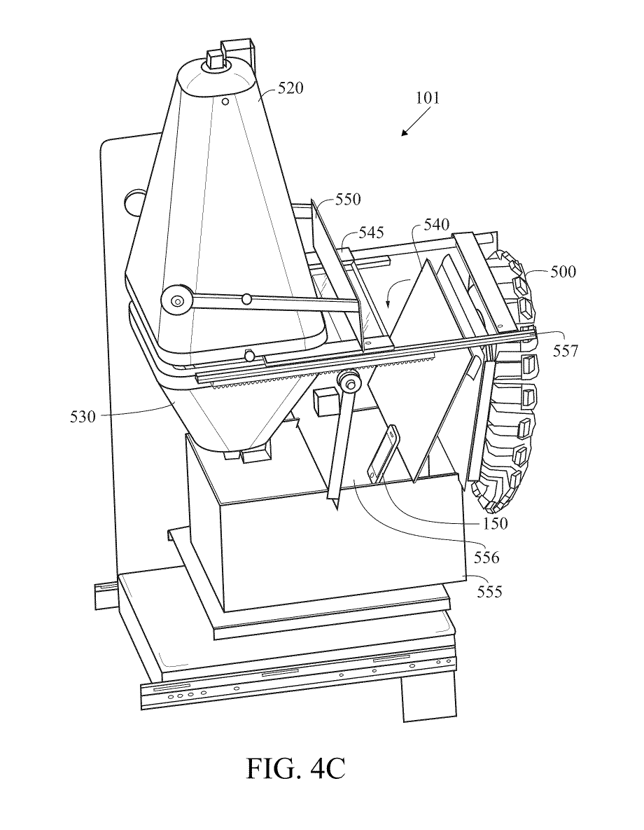

FIGS. 4, 4A, 4B, and 4C, show the automatic transport and binning of an electronic device 150 within the internal mechanism 101 of the kiosk 100. As shown in FIG. 4, the door 550 is lowered to reside above the transparent plate 545, which is then moved inward with the mobile phone 150 thereon. As shown in FIG. 4A, as the transparent plate 545 is moved inward, the mobile phone is blocked by the door 550 and engages binning plate 540 as the mobile phone begins to fall into an opening created by the inward movement of the transparent plate 545. As shown in FIG. 4B, once the mobile phone is on the binning plate 540, the binning plate 540 is slowly lowered on one side to open into the bin 555. As shown in FIG. 4C, the mobile phone 150 slowly falls through an opening 556 into the bin 555 to secure the mobile phone 150 and for collection at a later time. The entire process performed at a rate of speed to prevent damage to the electronic device being recycled.

The kiosk 100 is of a typical size and shape of a vending machine, such as a soda machine, coin changing machine, can recycling machine, or other vending machines. The housing 105 of the kiosk 100 protects the internal mechanism 101 and secures electronic devices submitted for recycling. The housing 105 is preferably constructed of a metal material, such as steel or aluminum, to prevent authorized access to the kiosk 100.

The inspection area 106 is preferably designed to permit a detailed visual inspection of an electronic device such as a mobile phone, tablet computer, e-reader, MP3 players, PDA. The walls of the inspection area are preferably white and/or mirrored to provide imaging of the electronic device.

The couplings from the kiosk 100 and to a remote computer are preferably a single coupling to a communications network such as the internet via wired LAN, wireless LAN, cellular or any other proprietary communications system. The Kiosk 100 preferably includes a processor 160 for processing the information obtained from the mobile phone and for controlling the components of the kiosk 100. Preferably, the processor 160 is a standard personal computer (“PC”) or other type of embedded computer running any operating system such as Linux or MAC OS. The processor 160 is most preferably a small form factor PC with integrated hard disk drive (“HDD”), central processing unit (“CPU”) and universal serial bus (“USB”) ports to communicate with the other components of the kiosk 100. One most preferred CPU is a DELL PC OPTIPLEX 780. Alternatively, the processing means is a microprocessor with a standalone motherboard which interfaces to a discrete HDD, power supply and the other components of the kiosk 100. The kiosk 100 preferably includes a memory 161 or other storage device, such as a disk drive, that stores the executable applications, test software, databases and other software required to operate the recycling kiosk 100.

The external communication component for the kiosk 100 preferably includes a wired Ethernet to provide connection to the internet, or alternatively the external communication component includes a wireless modem such as GSM, CDMA, 3G and 4G technologies for data communications.

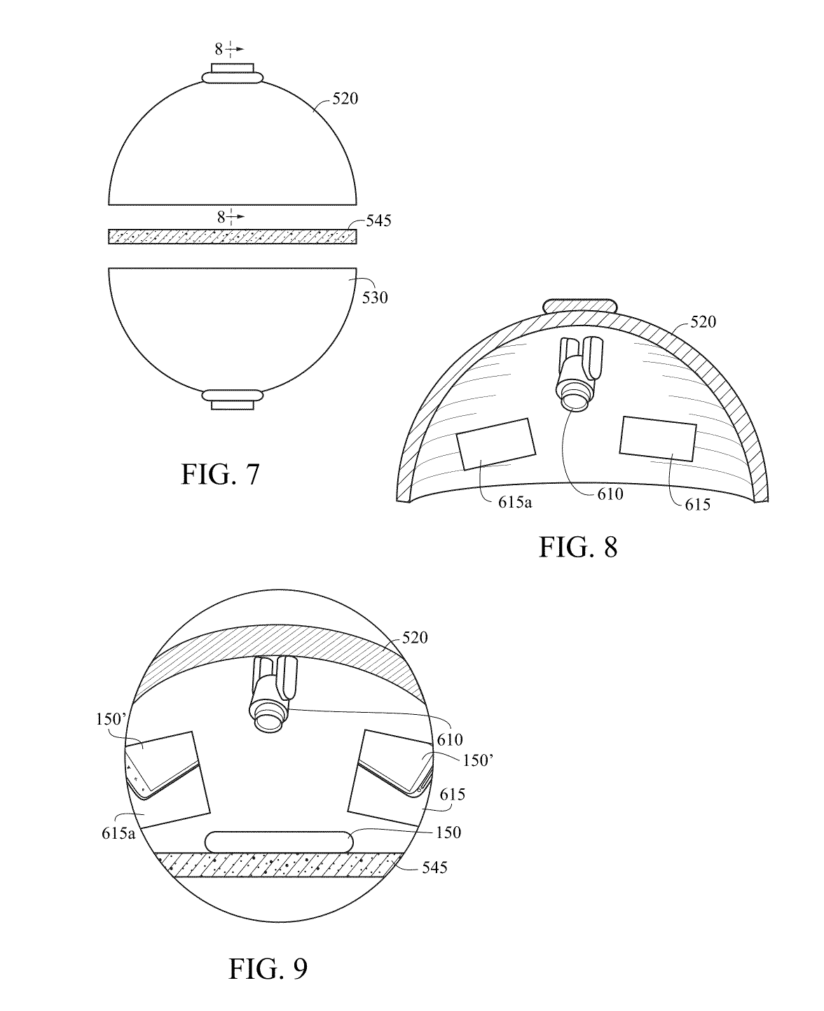

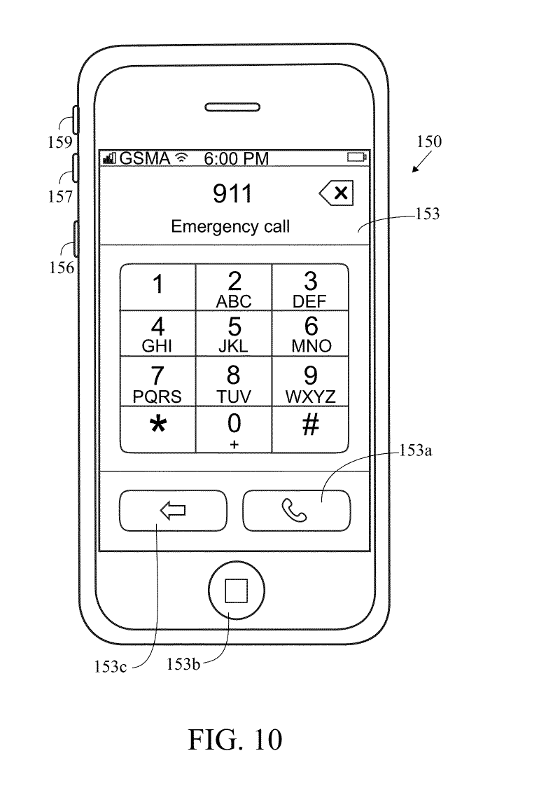

As shown in FIGS. 7-9, the visual inspection of an electronic device such as a mobile phone 150 in the inspection area 106 is preferably performed by at least one camera 610 within the upper chamber 520. The lower chamber 530 also preferably has at least one camera or other imaging component such as a scanner. Alternatively, the visual inspection is performed by multiple cameras. A preferred camera 610 is a 1 megapixel machine vision camera. If a single camera 610 is utilized in the inspection area 106, the camera 610 preferably is movable to increase a field of view of the inspection area 106 to inspect the electronic device 150 such as a mobile phone placed on the transparent plate 545. The camera 161 is preferably movable. Preferably the camera 610 is positioned to image a LCD screen 153 of the electronic device 150 to determine if the LCD screen 153 is damaged. The interior surfaces of the upper chamber 520 and lower chamber 530 preferably include mirrors 615 in order to optimize viewing of an electronic device positioned within the inspection area 106. As shown in FIG. 9, a reflection 150′ of a mobile phone 150 is illustrated. The camera 610 is also preferably movable to image a data port of the electronic device to determine the type of electrical connector 505 for the electronic device in order to perform an electrical analysis of the electronic device. Alternatively, the entire interior surfaces of the upper chamber 520 and the lower chamber 530 are mirrored for optimization of imaging of the electronic device. The camera(s) alternatively are CCD or CMOSS.

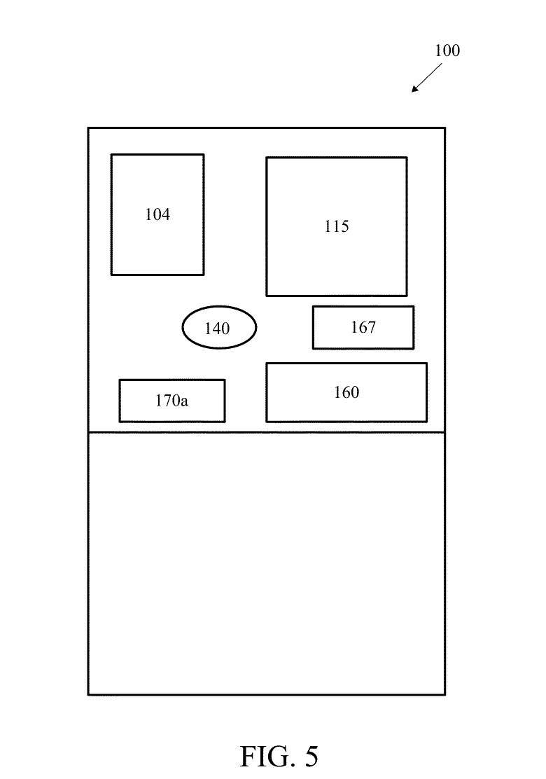

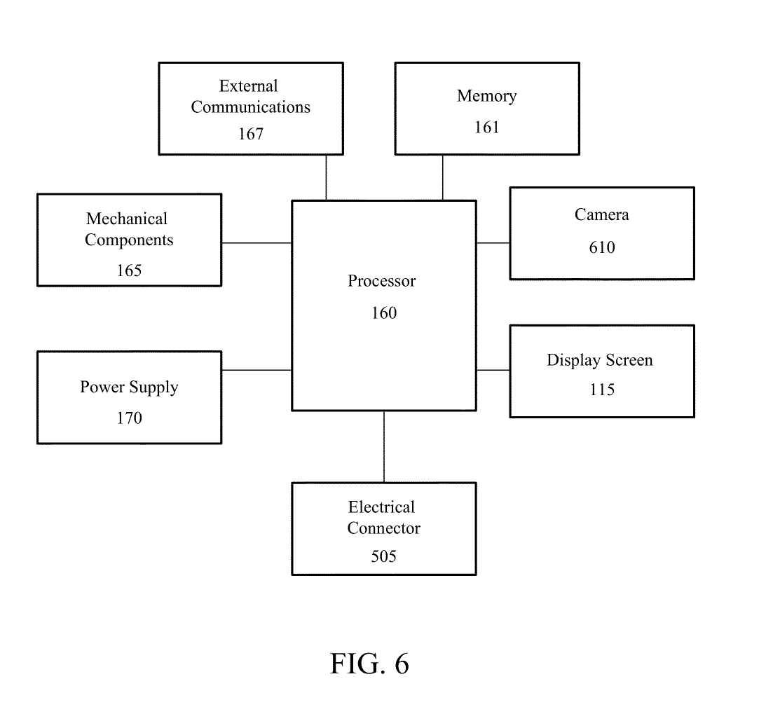

FIG. 6 is a block diagram of the main components of the kiosk 100. A processor 160 is preferably in communication with the other components of the kiosk 100. The memory 161 preferably contains a database of information on multiple mobile phones including images, physical characteristics, prices and other similar information. The external communications 167 preferably communicates through a wireless connection or Ethernet with a network to receive and transmit information to a remote site. The power supply 170 is preferably received through a plug-in connection to a wall outlet. The mechanical components 165 include the electrical connector carousel 500, the transparent plate 545, the binning plate 540, the door 550, and other similar components. The camera 610 or cameras, electrical connectors, and a user interface interact with the processor 160 as discussed above. FIG. 5 illustrates an internal back of a recycling kiosk 100. As shown a processor 160 is preferably a personal computer having a battery backup 170a, a wireless connection 167 for external communications, an electrical connection 140, a receipt dispenser 104 and a display screen 115.

The processor 160 identifies the electronic device 150 submitted for recycling using information from the visual inspection and user interface. The processor 160 also determines the proper electrical connector 505 for connection to the data port of the electronic device 150 using information obtained during the visual inspection or from the user interface. The processor 160 also directs and receives information from the electrical analysis of the electronic device 150 performed using the electrical connector 505 connected to the data port of the electronic device 150. The processor also preferably determines a financial remuneration for the submitted electronic device 150 based on the visual inspection, optionally the electrical analysis and data stored in the memory 161 of the kiosk or information provided externally through the external communication component 167.

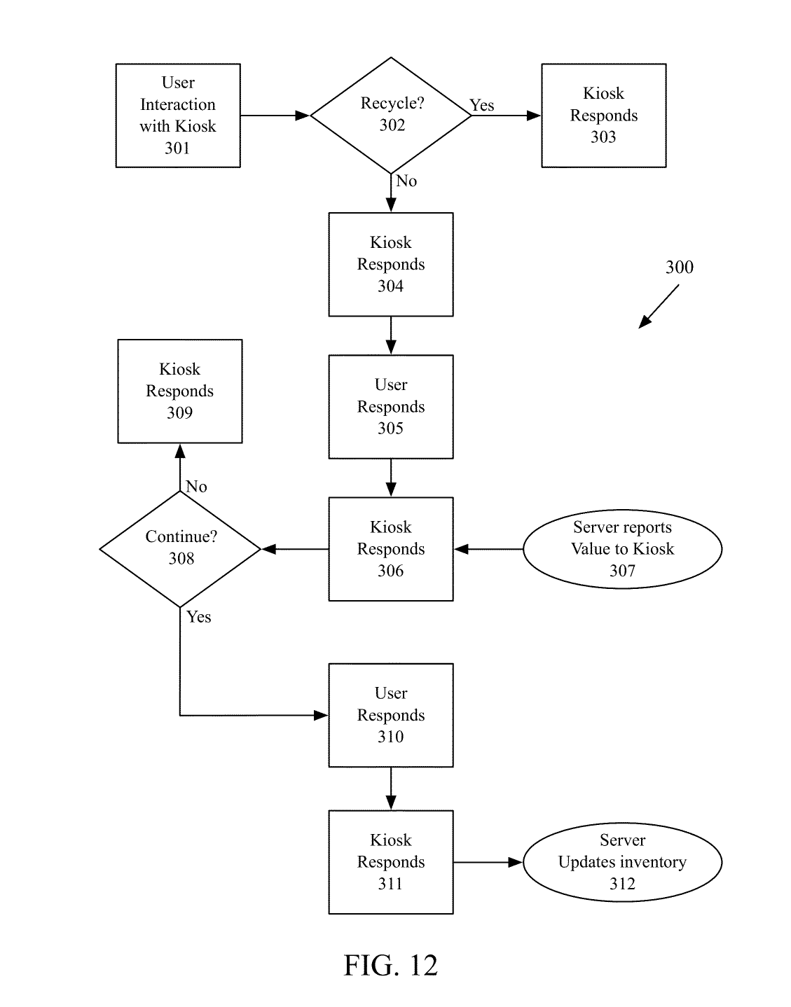

A flow chart for a preferred recycling method is shown in FIG. 12. At step 301 a customer elects to sell or recycle an electronic device. The customer checks to see if the electronic device is supported for sale/refurbishing from a list on the screen of the kiosk. The customer activates the on-screen menu system and either enters the phone model directly or goes through a series of menus to determine if the electronic device is eligible for sale or only for recycling. At decision block 302 it is determined if the electronic device is only available for recycling. If yes, (i.e. it is not on the list of electronic device available for reselling) the customer can insert the electronic device into receptacle at step 303 and the electronic device falls into bin 112 for recycling.

If the electronic device is supported for refurbishment/resale the customer is then encouraged to engage the testing/rating operation of the system. At step 304, the system has determined the correct connector to couple to the electronic device. Connectivity options and are not limited to cable, standard or proprietary connectors, hard docks, reading removable or external physical memory or other wireless methods like WiFi, Bluetooth, RFID, NFC, and the like. At step 305 the electronic device is connected and inserted into inspection area 106. If this has been done correctly, the customer is given some indication (e.g. a green light) and the system proceeds to step 306. At step 306 the electronic device is tested for operation using diagnostics and operating via, for example, the OMSI interface. The diagnostics preferably includes electrical and physical testing including testing the electronic device's battery, screen, memory, button functionality and structural integrity.

Preferably, the electronic device is imaged and analysis software is used to identify scratches, cracks, wear patterns, dents, broken or missing pieces, inclusion of features such as lenses, buttons, connectors, badges, labeling and/or branding. Identification may be done by image comparison or other similar methods where the image taken of the electronic device is normalized and compared to a reference image. Other inspection methods may be used in conjunction with visual and/or electrical testing including weighing to determine specific weight and use that data to further refine verification of manufacturer and verification of exact device model. In another embodiment, the photographic image is used to identify the correct manufacturer and model number/product number. Visual identification could include any combination of the following: calculations based upon measurement, physical (e.g., mm, inches), pixel count or other. Identification based upon electronic device dimensions, location/size of buttons, LCD and other physical characteristics. One camera or multiple cameras may be used to determine height, width, depth as needed. Identification based on OCR (Optical Character Recognition) of identifiers such as Carrier (for phone and tablet computers), brand, model, serial number, other identifiers. Identification based upon barcodes. Consumer may be asked to orient CE on its front, back, side and then asked to change orientation as needed. Consumer may even be asked to remove CE cover(s), batteries and the like in order to gain access to identifiable items, such alphanumeric or barcode data. The kiosk 100 provides a way to use visual inspection with electrical inspection to identify a device, determine its value, and reduce possible fraud.

In one embodiment, the kiosk 100 communicates with the carrier associated with a mobile phone to collect any information that could be germane to the device, including, for example, validation or authentication, registered ownership, account status, time in service, and the like. In some cases, when the customer's identification information does not match the registered owner information, the kiosk 100 automatically contacts the assumed owner in some manner (automated telephone call, email, text message, etc.) to alert the owner of the phone of the possible transaction.

Another feature of an embodiment of the kiosk 100 is to determine if there is personal information on the electronic device. This is determined by the presence of data in particular storage registers in the memory (e.g., quick-key stored numbers) or by looking at file types (jpegs, mp3's, etc.,), or just assuming all non-default storage locations must contain personal data. The customer is offered the chance to erase the data from the phone. One option allows the customer to request that the data be first downloaded and then sent to a location designated by the customer (e.g., email address, website, etc.). In another embodiment, there is a slot for the customer to enter a memory card (e.g. USB drive memory stick, etc.) whereupon the kiosk 100 uploads the data to the memory device. In still another embodiment, the kiosk 100 offers a web location from which the user retrieves the data at some later time if desired. In another embodiment, the user elects to have the data placed in another electronic device purchased by the customer at the kiosk 100 or in the location of the kiosk 100 or some other store. The customer preferably selects a user name and password to access the system provided storage location.

Once the value is determined, the value is provided at step 307 to the kiosk. The kiosk 100 then offers the customer a price or other remuneration for the phone that is typically less than the resale value. In other embodiments, the kiosk 100 offers the customer a price or remuneration that is at the current real-time market price. At step 308 it is determined if the user wishes to accept the offer. If not, the kiosk 100 proceeds to step 309 and opens the door and releases the electronic device back to the customer. If the user wishes to accept the offer, the kiosk 100 proceeds to step 310. At a point where the user accepts a price, the kiosk 100 may then lock down the inspection area to prevent further access to the electronic device by the user. The kiosk 100 then disconnects any cables that have been attached. At step 310, the user indicates acceptance of the decision by confirming on the keypad or touch-screen. At this point the kiosk 100 proceeds with deleting the personal data from the electronic device. In addition, once the transaction is confirmed, the kiosk 100 tags the electronic device with a transaction number that is associated with the diagnostic data and the transaction itself. This is preferably a printed adhesive label that is affixed physically to the phone and/or the loading of electronic data corresponding to the transaction number onto the phone itself for traceability purposes.

At step 311, the kiosk 100 completes any additional testing and diagnostics of the electronic device, disconnects the cable from the electronic device, and prints a receipt for the customer. Transfer of funds may be authorized via the kiosk 100 by crediting a customer credit card or account by dispensing cash, or by dispensing a voucher or coupon. At step 312 the kiosk 100 updates its inventory database and transmits the update via a communications network to a kiosk server.

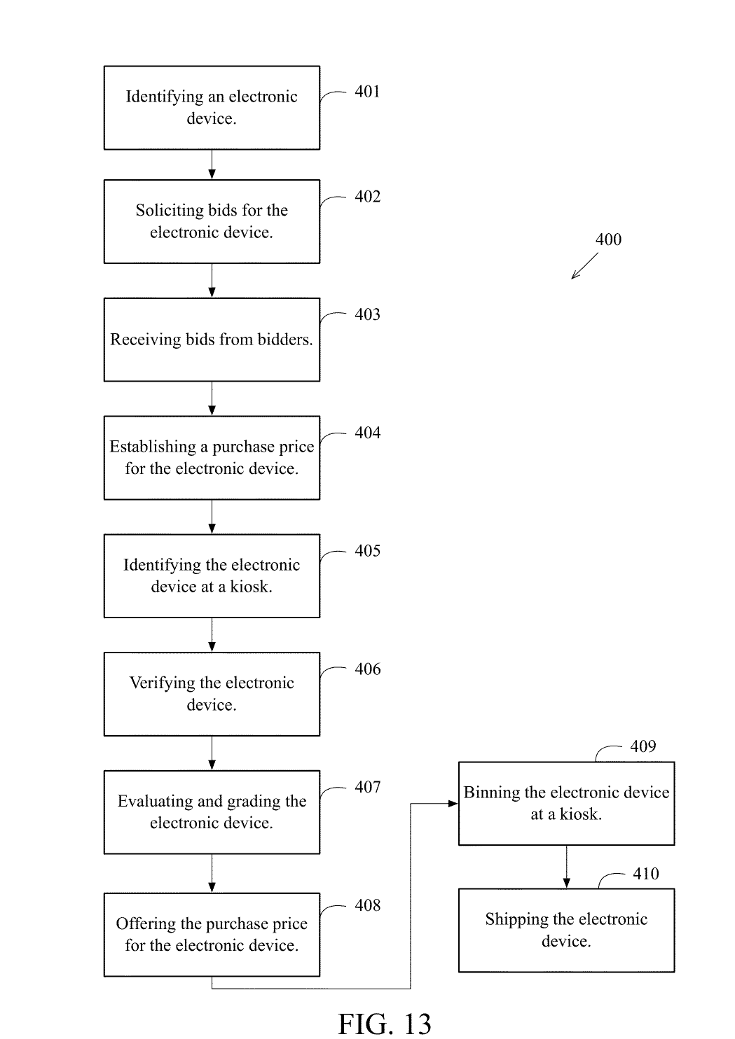

One preferred method for a pre-acquisition auction is illustrated in the flow chart of FIG. 13. A method for analysis of an electronic device and financial remuneration to a user for submission of the electronic device is generally designated 400. At block 401, an electronic device is identified. At block 402, bids are solicited for a used model of the electronic device in a predetermined condition. The bids are preferably solicited online through a website and the bidders are preferably pre-qualified. At block 403, bids for the used model of the electronic device are received from a plurality of bidders. At block 404, a purchase price to pay for the used model of the electronic device is set based on the plurality of bids received from the plurality of bidders. Typically, the purchase price is based on the winning bid. The shipping information for the winning bidder is preferably obtained at this time. At block 405, a used model of the electronic device is identified at a recycling kiosk for the electronic device. Preferably, a consumer desires to recycle the electronic device. At 406, the integrity of the used model of the electronic device is verified at the recycling kiosk. Preferably, the condition of the electronic device is established at the kiosk, with the kiosk determining any damage to the electronic device based on visual and electronic analysis of the electronic device. At block 407, the electronic device is evaluated and graded. At block 408, the purchase price for the used model of the electronic device is offered to a consumer at the kiosk. At block 409, the electronic device is automatically binned after purchasing the used model of the electronic device from the consumer at the kiosk. At block 410, the electronic device is shipped to the winning bidder.

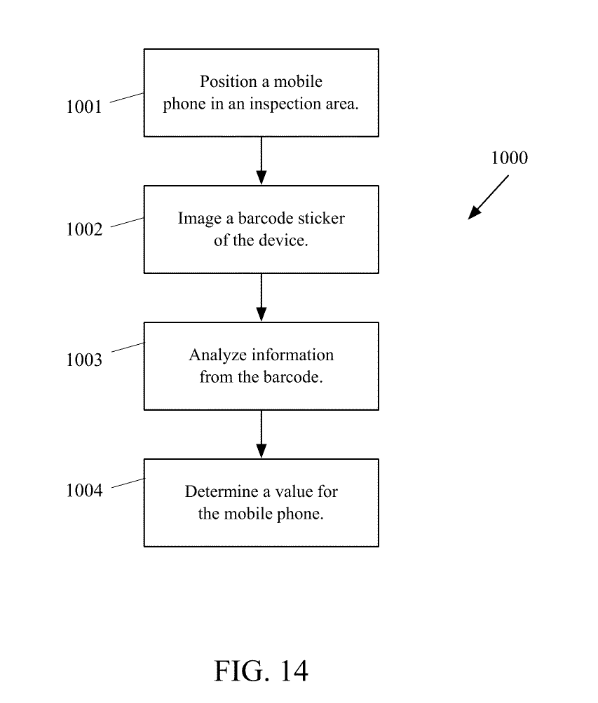

One preferred method of the present invention is illustrated in the flow chart of FIG. 14. The method 1000 begins at block 1001 with an electronic device 150 positioned within an inspection area, 106 of a kiosk 100 wherein the inspection area has a camera. At block 1002, the method further comprises imaging a barcode sticker of the electronic device. At block 1003, the method includes analyzing information derived from the barcode sticker of the electronic device. At block 1004, the value of the mobile phone is determined as discussed in more detail below. Preferably, the method further comprises automatically binning the electronic device after determining the value of the electronic device. Additionally, the method preferably comprises instructing the user to remove a back panel and a battery of the electronic device prior to positioning the electronic device in the inspection area.

Preferably, the kiosk 100 of the method comprises a housing 105, the housing 105 comprising a user interface on an exterior surface of the housing for the user to input information, an upper dome and a lower dome, wherein the upper dome and the lower dome comprise a plurality of mirrors. The kiosk 100 further comprises an upper chamber camera, a lower chamber camera and a transparent surface. The kiosk 100 further comprises a processor 160 within the housing and in communication with the at least one camera, the processor 160 configured to identify the brand and model number of the electronic device based on at least one of the information from the user and the images from the at least one camera, the processor 160 configured to determine a financial remuneration value for the electronic device.

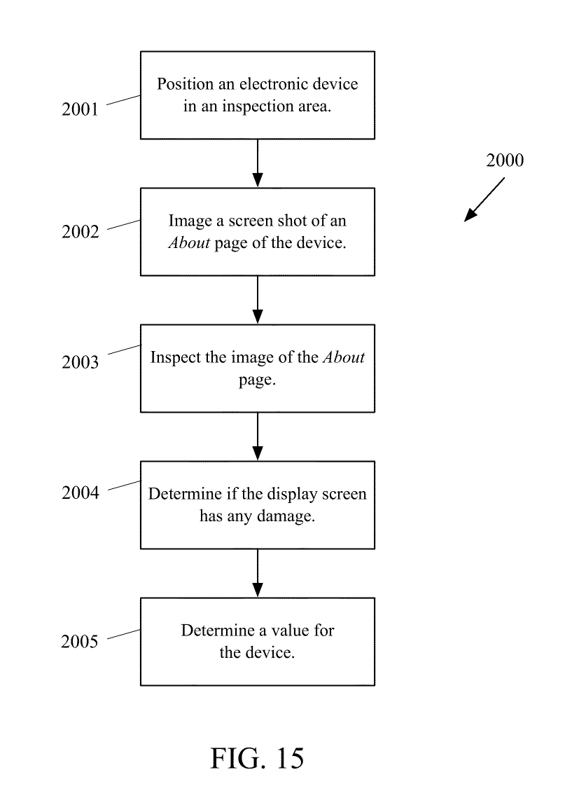

An alternative method of the present invention is illustrated in the flow chart of FIG. 15. The method 2000 begins at block 2001 wherein an electronic device is placed in an inspection area of a kiosk 100, the inspection area 106 having an imaging component such as a camera. At block 2002, the method comprises imaging a screen shot of a page (preferably an about page) of the electronic device. At block 2003, the screen shot of the page of the electronic device obtained by at least one imaging component disposed in the inspection area is inspected. At block 2004, it is determined if a display screen of the electronic device. At block 2005 a value for the electronic device is determined. The method preferably comprises comparing information derived from the barcode sticker to information derived from the page to determine whether the information agrees or conflicts.

Alternatively, the method comprises imaging a screen shot of a known screen of a battery charging screen display of the electronic device and inspecting the screen shot of the known screen of the battery charging screen display of electronic device obtained by at least one camera.

The present invention further includes is a dome shaped apparatus, the dome shaped apparatus comprising an upper dome, a lower dome. The upper and lower dome comprises a plurality of walls, wherein the plurality of walls are composed of mirrors. The dome shaped apparatus further comprises a transparent surface and at least one camera, the camera capable of obtaining a multiple views of an electronic device placed within the dome shaped apparatus. The upper dome preferably comprises an upper chamber camera. The lower dome preferably comprises a lower chamber camera. Preferably, a combination of each of the upper dome and lower dome cameras and the plurality of mirrors allow for an image of the device placed on the transparent surface. Preferably, the combination of each of the upper dome and lower dome cameras and the plurality of mirrors allow for a 360 degree of the electronic device placed on the transparent surface. Preferably, each of the upper dome and lower dome cameras are moveable.

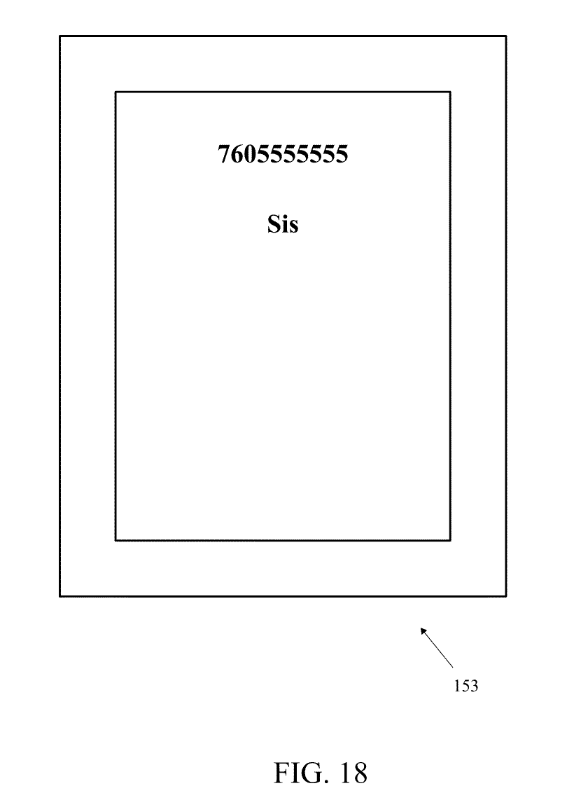

Alternatively, the method begins with a mobile phone 150 positioned within an inspection area 106 of a kiosk 100. The mobile phone is powered up. A term is inputted into the mobile phone 150 for display on a LCD screen of the mobile phone 150. A preferred term is a telephone number for display on a LCD screen 153 as shown in FIG. 18. The term may also be a word, characters, or like inputs. The LCD screen 153 is inspected for damage such as cracks, pixel defects, discoloration and the like. The kiosk 100 inspects the LCD screen 153 for defects in the display of the telephone number or like term. Further, the luminescence of the LCD screen 153, particularly the telephone number, can also be measured to determine if the luminescence is performing at levels set forth by the manufacturer of the mobile phone 150. An optional electrical analysis is performed on the mobile phone 150 as discussed in more detail below. Lastly, the value of the mobile phone is determined as discussed in more detail below.

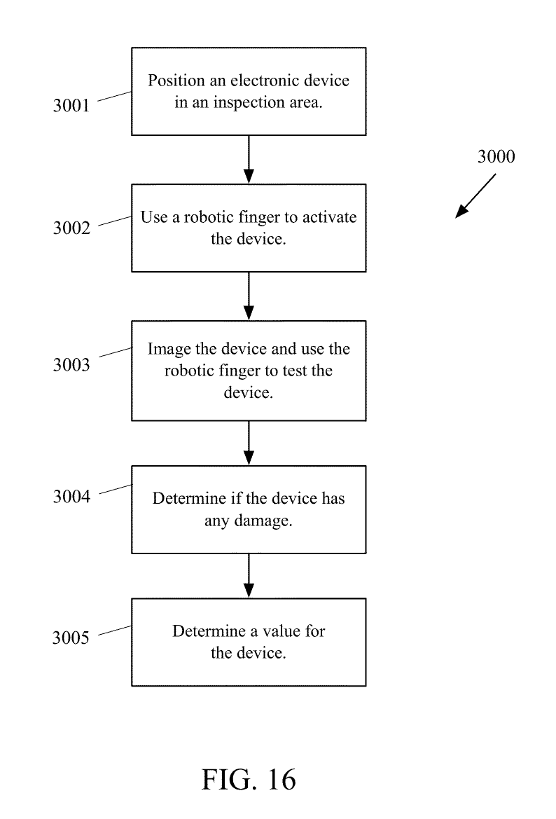

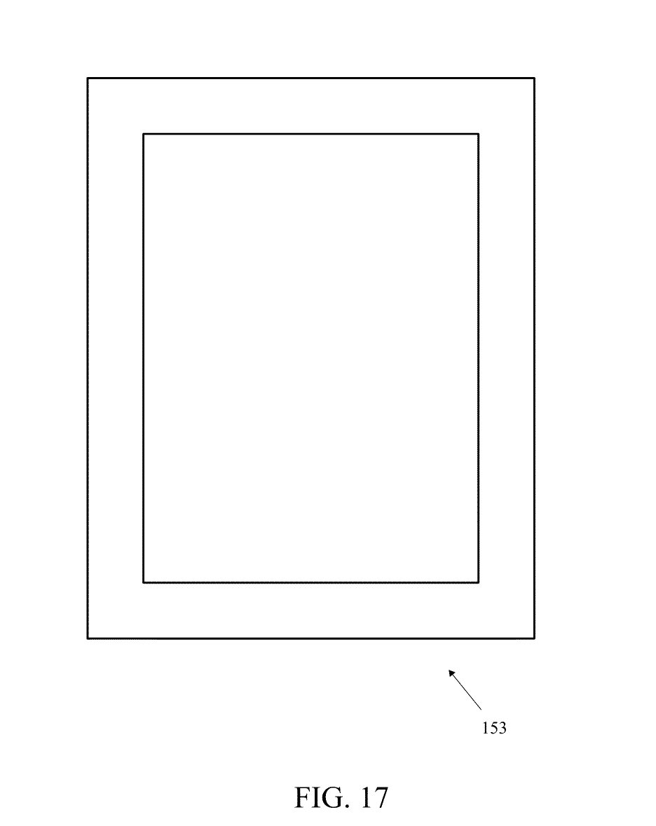

An alternative method of the present invention is illustrated in the flow chart of FIG. 16. The method 3000 begins at block 3001 with an electronic device 150 positioned within an inspection area 106 of a kiosk 100, the inspection area having a camera. At block 3002, a robotic finger is used to activate the electronic device. At block 3003, the electronic device is imaged. At block 3004, the image of the electronic device obtained by the at least one camera disposed in the inspection area is inspected to determine if the electronic device has any defects. At block 3005, a value for the electronic device is determined.

Preferably, the method further comprises automatically binning the electronic device after determining the value of the electronic device. The method preferably comprises using the robotic finger to call a test phone number or alternatively to send a text a test phone number. The text preferably comprises each letter of the alphabet which allows determining the functionality of all letters of the keyboard. The method further comprises the text comprises a character string comprising the numbers 1 through 10, allowing determination of the functionality of all numbers on the keyboard. Further, the robotic finger may be used to send a text comprising each symbol on the keyboard. The method further comprises using the robotic finger to active a camera mode of the electronic device.

Yet another aspect of the present invention is an apparatus for recycling electronic devices. The apparatus comprises an inspection area, a transparent plate within the inspection area, a robotic finger within the inspection area and at least one camera within the inspection area. The robotic finer is programmed to inspect an electronic device positioned on the transparent plate. Preferably, the robotic finger has an inspection end composed of a polymer material similar to human skin. The robotic finger can swipe on touchscreen of an electronic device. The electronic device is a mobile phone, tablet computer, or MP3 player. The apparatus preferably comprises a robotic finger having a plurality of phalanges and joints for multi-dimensional movement. Further, the robotic finger has a rotating base for 360 degrees movement. Additionally, the robotic finger has an oscillator for vertical movement. The robotic finger comprises a plurality of modular components for dimensional changes to the size and shape of the robotic finger. The robotic finger comprises an electrical connection for connection to a port of the electronic device.

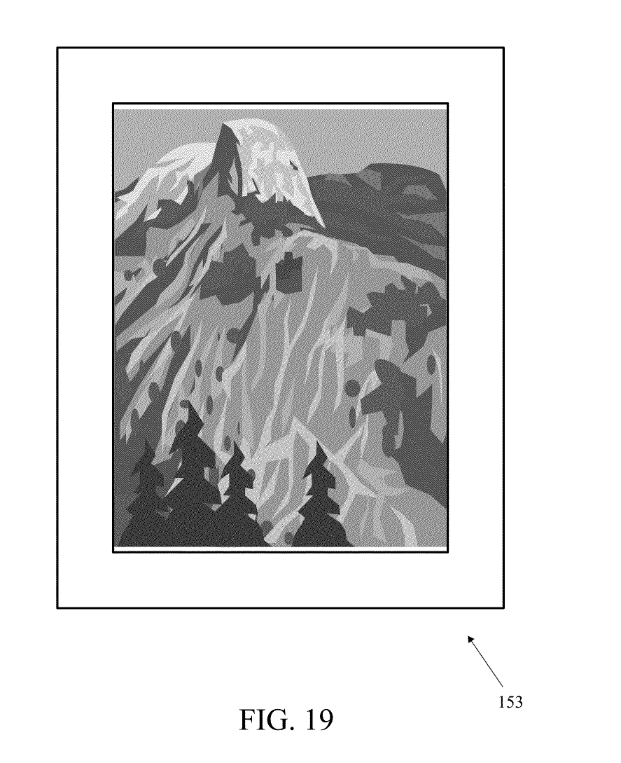

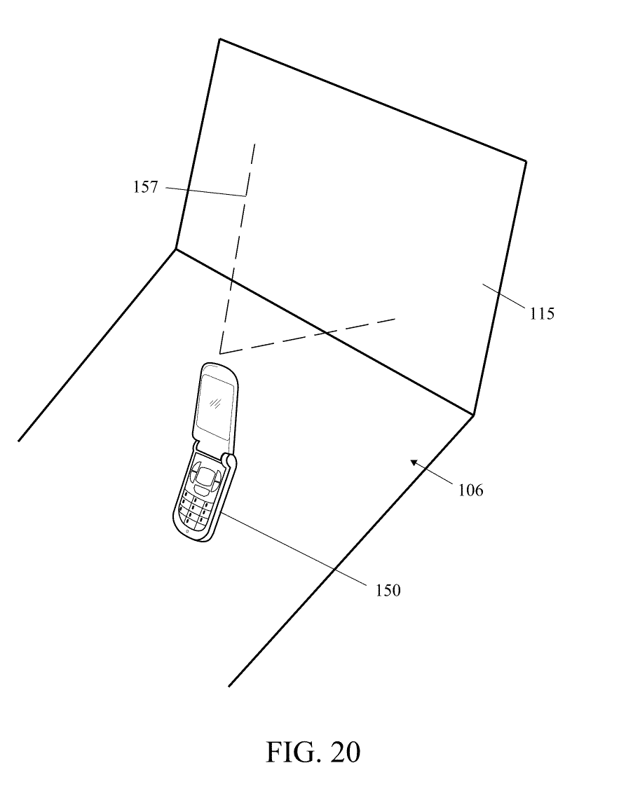

An alternative method of the present invention comprises a mobile phone 150 positioned within an inspection area 106 of a kiosk 100. The mobile phone is powered up. A known image is displayed on a LCD screen of the mobile phone 150. One example of a known image for display on a LCD screen 153 is a national park such as Yosemite National Park as shown in FIG. 19. An alternative know image is a start up logo of a carrier for the mobile phone such as the well-known VERIZON logo or the AT&T logo. The known image may be sent to the mobile phone by the kiosk 100 either directly through electrical connection or wirelessly by telephoning the mobile phone 150. The LCD screen 153 is inspected for damage such as cracks, pixel defects, discoloration and the like. The kiosk 100 inspects the LCD screen 153 for defects in the display of the known image by comparing the displayed known image with a stored known image, preferably using optical recognition software. Further, the luminescence of the LCD screen 153, particularly the telephone number, can also be measured to determine if the luminescence is performing at levels set forth by the manufacturer of the mobile phone 150. An optional electrical analysis is performed on the mobile phone 150 as discussed in more detail below. The value of the mobile phone is determined as discussed in more detail below.

One example of a known image for display on a LCD screen 153 is a national park such as Yosemite National Park as shown in FIG. 19. An alternative know image is a start up logo of a carrier for the mobile phone such as the well-known VERIZON logo or the AT&T logo. The known image may be sent to the mobile phone by the kiosk 100 either directly through electrical connection or wirelessly by telephoning the mobile phone 150. At block 3004, the LCD screen 153 is inspected for damage such as cracks, pixel defects, discoloration and the like. The kiosk 100 inspects the LCD screen 153 for defects in the display of the known image by comparing the displayed known image with a stored known image, preferably using optical recognition software. Further, the luminescence of the LCD screen 153, particularly the telephone number, can also be measured to determine if the luminescence is performing at levels set forth by the manufacturer of the mobile phone 150. At block 3005, an optional electrical analysis is performed on the mobile phone 150 as discussed in more detail below. At block 3006, the value of the mobile phone is determined as discussed in more detail below.

Preferably, visual inspection and recognition software is utilized by the kiosk 100 to analyze a mobile phone 150. In one preferred method, a recognition algorithm is applied to a specific make and model of a mobile phone 150. The visual inspection and recognition software determines the borders of a mobile phone 150 under inspection to determine the external dimensions of the mobile phone 150. The external dimensions are utilized to determine a subset of possible mobile phones from a master database of mobile phones stored in the memory 161 of the kiosk 100 or available online to the kiosk 100 using external communications. The visual inspection and recognition software then preferably uses a set of secondary and tertiary features to further distinguish the mobile phone 150. These secondary and tertiary features can include placement and size of the display screen, placements and size of the keyboard, unique buttons, placement of ports, and other distinguishing features. Once an exact make and model of the mobile phone is determined, the visual inspection and recognition software subtracts an image of the mobile phone 150 from an image of a perfect mobile phone for the same make and model. The result of the subtraction is preferably a quantifiable number of pixels that are calibrated into categories of broken or missing parts, cracked screen, and low, medium or high wear.

Alternatively, the visual inspection is performed using neural network pattern recognition techniques to identify the mobile phone 150, then filter algorithms are utilized to determine defects such as cracked screens. Further, those skilled in the pertinent art will recognize that other visual inspection techniques may be employed without departing from the scope and spirit of the present invention.

Further, visual inspection optionally includes obtaining a heat signature for the mobile phone 150. One preferred method of obtaining a heat signature of a mobile phone 150 is to raster a laser across the mobile phone to characterize a heat decay profile of the submitted mobile phone 150. This heat decay profile is then compared to a heat decay profile for a perfect sample of the same mobile phone 150. The heat decay profile indicates the wear of the external surface of the mobile phone 150, which is used in calculating the financial remuneration for the mobile phone 150.

Yet another method of the present invention comprises positioning an electronic device in an inspection area of a recycling kiosk 100, powering up the electronic device and displaying a known image on a LCD screen of the electronic device. The known image on the LCD screen of the electronic device is compared with a stored duplicate of the known image stored on the recycling kiosk to determine any defects in the LCD screen of the electronic device and to define an analyzed electronic device. The method further comprises determining a value for the analyzed electronic device.

In one embodiment of this method, the known image is a start-up image for the carrier of the electronic device. In an alternative embodiment, the known image is an image of a national park. The method may further comprise performing an electrical analysis of the electronic device.

AS shown in FIG. 21, a robotic finger mechanism 725 swipes a touchscreen display 153 of a mobile phone 150 positioned on transparent plate 700 of the inspection area of the kiosk.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes modification and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

We claim as our invention the following:

1. A method for analysis of an electronic device and financial remuneration to a user for submission of the electronic device, the method comprising:
positioning an electronic device in an inspection area of a kiosk; the inspection area having at least one camera and a non-visible spectrum lighting;
imaging an ID label of the electronic device;
analyzing information derived from the ID label of the electronic device; and
determining a value for the electronic device.

2. The method according to claim 1 wherein the non-visible spectrum lighting is near-infrared lighting.

3. The method according to claim 1 further comprising instructing the user to remove a back panel and a battery of the electronic device prior to positioning the electronic device in the inspection area.

4. The method according to claim 1 wherein the ID label comprises an RFID tag, near-field communication device, QR tag, a barcode, a text or a manufacturer ID tag.

5. The method according to claim 1 wherein the kiosk further comprises:
a housing;
a user interface on an exterior surface of the housing for the user to input information;
an upper chamber and a lower chamber, wherein the upper chamber comprises a plurality of mirrors;
an upper chamber camera;
a lower chamber camera;
a transparent surface; and
a processor within the housing and in communication with the at least one camera, the processor configured to identify the brand and model number of the electronic device based on the images from the at least one camera, the processor configured to determine a financial remuneration value for the electronic device.

6. A method for analysis of an electronic device and financial remuneration to a user for submission of the electronic device, the method comprising:
positioning an electronic device in an inspection area of a kiosk, the inspection area having at least one camera;
imaging a screen shot of a page of the electronic device,
inspecting the screen shot of the page of the electronic device obtained by at least one camera disposed in the inspection area to determine if the electronic device has any defects; and
determining a value for electronic device.

7. The method according to claim 6 further comprising automatically binning the electronic device after determining the value of the electronic device.

8. The method according to claim 6 wherein the page is an about page of the electronic device, and further comprising comparing information derived from the ID label to information derived from the about page.

9. The method according to claim 6 further comprising analyzing the content of the page and comparing the analyzed content to standard data of the content of the page.

10. The method according to claim 6 further comprising extracting text on the screen, MEID number, IMEI number, serial number or other identifying components of the electronic device.

11. The method according to claim 6 wherein the inspection area of the kiosk comprises:
an upper chamber;
a lower chamber;
the upper and lower chamber comprising a plurality of walls, the plurality of walls of the upper chamber composed of mirrors;
a transparent surface; and
at least one camera, the camera capable of obtaining a multi-dimensional view of an electronic device placed within the apparatus.

12. The method according to claim 11 wherein the transparent surface can rotate, allowing for multi-dimensional views of the electronic device placed on the transparent surface.

13. The method according to claim 11 wherein the upper chamber comprises an upper chamber camera.

14. The method according to claim 11 wherein the lower chamber comprises an imaging device.

15. The method according to claim 14 wherein a combination of the each of the upper chamber and lower chamber cameras and the plurality of mirrors allow for a multi-view image of the electronic device placed on the transparent surface.

16. The method according to claim 14 wherein a combination of the each of the upper chamber and lower chamber cameras and the plurality of mirrors allow for a 360 degree of the electronic device placed on the transparent surface.

17. A method for analysis of an electronic device and financial remuneration to a user for submission of the electronic device, the method comprising:
positioning an electronic device in an inspection area of a kiosk, the inspection area having at least one camera;
imaging a screen shot of a known screen of a battery charging screen display of the electronic device,
inspecting the screen shot of the known screen of the battery charging screen display of the electronic device obtained by at least one camera disposed in the inspection area to determine if the electronic device has any defects; and
determining a value for electronic device.

18. A method for reading a serial number of a mobile phone for the purpose of tracking the mobile phone, the method comprising:
requesting a user at a kiosk to dial *#06# into the mobile phone;
displaying an IMEI number or unique serial number for the mobile phone on a display screen of the mobile phone; and
reading the IMEI number or unique serial number for the mobile phone with an imaging system utilizing OCR to identify and track the serial number of the mobile phone.
